(19) United States
(12) Patent Application Publication
(10) Pub. No.: US 2013/0066922 A1
(43) Pub. Date: Mar. 14, 2013

(54) MANAGING DATA RECEIVED FROM MULTIPLE SOURCES FOR GENERATING A CONTACT PROFILE FOR SYNCHRONIZING WITH THE MULTIPLE SOURCES

(71) Applicants: Myung Ryul Jang, Renton, WA (US); Tim Miller, Seattle, WA (US); Michael Squires, Seattle, WA (US); Debbie Cargile, Seattle, WA (US)

(72) Inventors: Myung Ryul Jang, Renton, WA (US); Tim Miller, Seattle, WA (US); Michael Squires, Seattle, WA (US); Debbie Cargile, Seattle, WA (US)

(73) Assignee: WhitePages, Inc., Seattle, WA (US)

(21) Appl. No.: 13/609,216

(22) Filed: Sep. 10, 2012

Related U.S. Application Data
(60) Provisional application No. 61/533,126, filed on Sep. 9, 2011.

(51) Int. Cl. G06F 17/30

(52) U.S. Cl. 707/802; 707/E17.044

(57) ABSTRACT

Technology is disclosed for providing contact management services. Contact information (e.g., phone numbers, addresses, email addresses, etc.) are collected from multiple, different sources (e.g., a mobile phone, a web server, a social media web site, SMS, an App, etc.) Contact information can also be entered in a free-form format and parsed into structured data that is associated with a contact card. A contact card stores the contact information and the source of the information. Contact cards can be aggregated into a merged contact card that includes information from the multiple, different sources, without loosing the original information. The merged contact card can be disaggregated into its constituent contact cards and used to create other contact cards. A user can associate one or more of their contact cards with a group. The group is optionally notified when the users changes its contact information.

### PRIORITY

This application claims priority to U.S. Provisional Application No. 61/533,126 filed Sep. 9, 2011, which is incorporated herein in its entirety by reference.

### BACKGROUND

Universal contact management has become a complex problem based at least in part on the rise of online identities, profiles, address/contact books, and social networking websites that are each available to a growing number of people. The days of pen-and-paper-based address books has largely passed, leaving an abundance of choices for storing important information (e.g., family information, business contacts, various telephone numbers, addresses, directions, reviews, email addresses/messages, and SMS information). Future technology will likely provide additional information that may become critical to our daily lives. Society may find it necessary to store biometric data, genetic information, or other information, for security or for other purposes.

There have been attempts to solve the problems faced when aggregating, changing, prioritizing, and searching through contact-related information. For example, “connected contact” concepts connect users on a 1-to-1 basis, usually from one contact management system (“CMS”) to other users on that same contact management system. For example, John and Mary may connect to CMS1. When Mary updates her phone number on CMS1, John will automatically receive in his CMS1 address book, Mary's new phone number. This concept is inefficient for sending one user's updates to more than one other user.

A problem with the current technology is that it inhibits the disaggregation of compiled contact information into its constituent parts so that it may be useful in prioritizing and/or organizing information. Another problem with current technology, such as with those applications that allow “linking” contacts from multiple sources (e.g., Gmail, Yahoo, LinkedIn, etc.), is that when a user's number changes the user must update the change in each of the linked sources. For example, when a user changes to a new phone number (e.g., 666.666.6666) from an old phone number (e.g., 555.555.5555) that was previously linked (i.e. aggregated) from both Gmail and Yahoo, the user must update both of Gmail and Yahoo with the new 666.666.6666 phone number. Yet another problem with current technology is that multiple contacts and contact elements (e.g., cell phone, work phone, address, etc.) often require manual entry for each contact and/or contact element.

These and other problems inhibit the efficient use of universal contact management systems.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a block diagram of a basic and suitable computer that may employ aspects of the described technology.

FIG. 2 is a block diagram illustrating a simple, yet suitable system in which aspects of the described technology may operate in a networked computer environment.

FIG. 3 is a block diagram illustrating a simple, yet suitable system in which data is gathered from external sources and aggregated into contact cards associated with a particular contact.

FIG. 4 is a flow chart illustrating how to update groups in terms of contact information that was changed.

Note: the headings provided herein are for convenience and do not necessarily affect the scope or interpretation of the described technology.

### DETAILED DESCRIPTION

Introduced below are technologies that enable the aggregation of contact information from multiple sources, deduplication and presentation of contacts, editing of aggregated contacts, and disaggregation of contacts to their original and new sources. Certain aspects of this technology relate to U.S. Provisional Application No. 61/533,126.

The technology enables a user's private address book, for example, to aggregate public and private contact information as well as manual updates from third parties, without actually changing the contents of the user's address book until approved by the owner of the address book.

The technology also introduces the concept of a “shared content group,” which provides an efficient paradigm for collecting and exchanging contact information among a group of people who have established relationships.

In some embodiments, the described technology collects contact data from multiple contact sources and automatically generates, using the collected data, one or more electronic contact cards for each contact in a user's electronic address book. Data can be collected via any telecommunication protocol, such as the IEEE 802 standards, WiFi, cellular networks, 3G or LTE, etc. Various algorithms and/or protocols can be used over the telecommunication networks to communicate the data, such as HTTP/S, SMS, etc.

A contact card contains contact data gathered from a contact source (e.g., Facebook®, Google®, iPhone®, or via manual entry) and an indication of which contact source originally provided the contact data. Contact data may include home/work email addresses, phone numbers, professional titles, affiliations, and other data. Once collected, contact data is maintained in the original format used by the originating contact source.

A particular contact can have multiple contact cards, including at least one for each contact source. Contact “John Doe,” for example, may have a contact card that includes a home phone number that was retrieved from Facebook®. John Doe may have another contact card from Google® that includes an email address, a next contact card that contains a work phone number retrieved from the user's iPhone®, and yet another contact card with the contact's birthday, which was inputted manually. Using a novel algorithm, the described technology can aggregate and organize the contact card data into a single “rolled up” or merged contact card to represent a single instance of the contact (e.g., John Doe) while still maintaining and synchronizing from the contact source that provided the data. For example, when a contact card gets added to a contact, the technology can produce a single merged contact card that accumulates all of the contact information from each contact card that belongs to the contact. Merging data from a high number of contact sources increases the accuracy of contact data and allows for trend analysis and calculation (e.g., forecasting the movement of users between geographical and/or online locations). In one embodiment, a merged contact card may be partially or fully unmerged (or “undone”) to separate one or more individual contact cards from the merged contact card.

Changes to a contact card can be performed manually or automatically by the described technology. For example, the technology can synchronize the changes made at a specific contact source to its corresponding contact card and, optionally, the technology can update data that has been changed on a contact card at its corresponding contact source. The described technology can notify a user if a change has occurred on any of the contact cards and allow the user to manually accept/reject the changes. Alternatively, the changes can be accepted and/or rejected automatically.

In another embodiment, the user may define multiple contact groups to manage different types of contacts. For example, a user may define a contact group for her family, and another contact group for her coworkers. A contact group can be shared among multiple end users. For instance, a user may create a school PTA contact group and share it with the members of the PTA. In one embodiment, when a user updates her personal contact card, the described technology may automatically share the updates with other members of a shared contact group.

In one embodiment as further explained below or in the incorporated U.S. Provisional No. application 61/533,126, the disclosed technology includes a simplified user interface for manually entering contact data. The user interface may include a simple text box that allows contact data to be inputted in various different formats. The user interface can communicate with an intelligent backend process that parses the free-form text into contact data.

Although the techniques of the described technology are presented in the context of an electronic address book or contact list, the technology can be utilized in other scenarios and should not be limited to contact information. For instance, the described technology may be utilized to efficiently aggregate and display other types of information, such as calendars, agendas, to-do lists, etc. Calendars, for example, may be online, local to a user's personal computer or mobile device, or maintained by a third-party. In one embodiment, the described technology may collect calendar data from multiple calendar sources and automatically generate, using the collected data, one or more electronic calendar cards for one or more days in a user's (or group's) electronic calendar.

Various embodiments of the technology will now be described. The following description provides specific details for a thorough understanding and enabling description of these embodiments. One skilled in the art will understand, however, that the described technology may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this Detailed Description section.

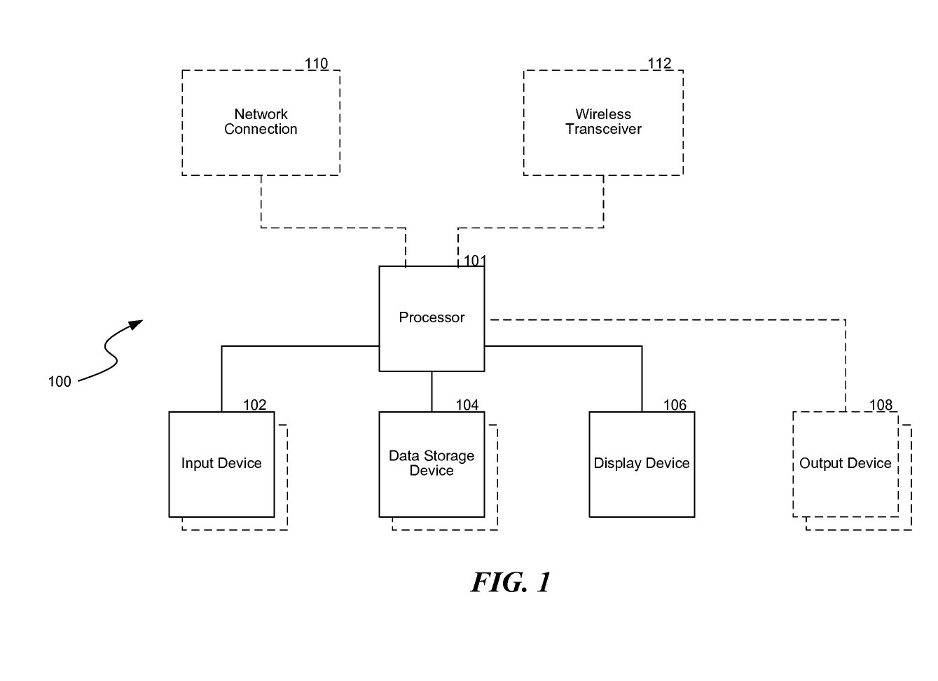

FIG. 1 and the following discussion provide a brief, general description of a suitable computing environment in which aspects of the described technology can be implemented. Although not required, aspects of the technology may be described herein in the general context of computer-executable instructions, such as routines executed by a general or special purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the technology may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

The described technology can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines may be located in both local and remote memory storage devices. Those skilled in the relevant art will recognize that portions of the described technology may reside on a server computer, while corresponding portions reside on a client computer. Data structures and transmission of data particular to aspects of the technology are also encompassed within the scope of the described technology.

Referring to FIG. 1, in some embodiments, the described technology employs a computer 100, such as a personal computer, workstation, tablet, or smart phone, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard, keypad, touch screen and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN), or the Internet (not shown in FIG. 1).

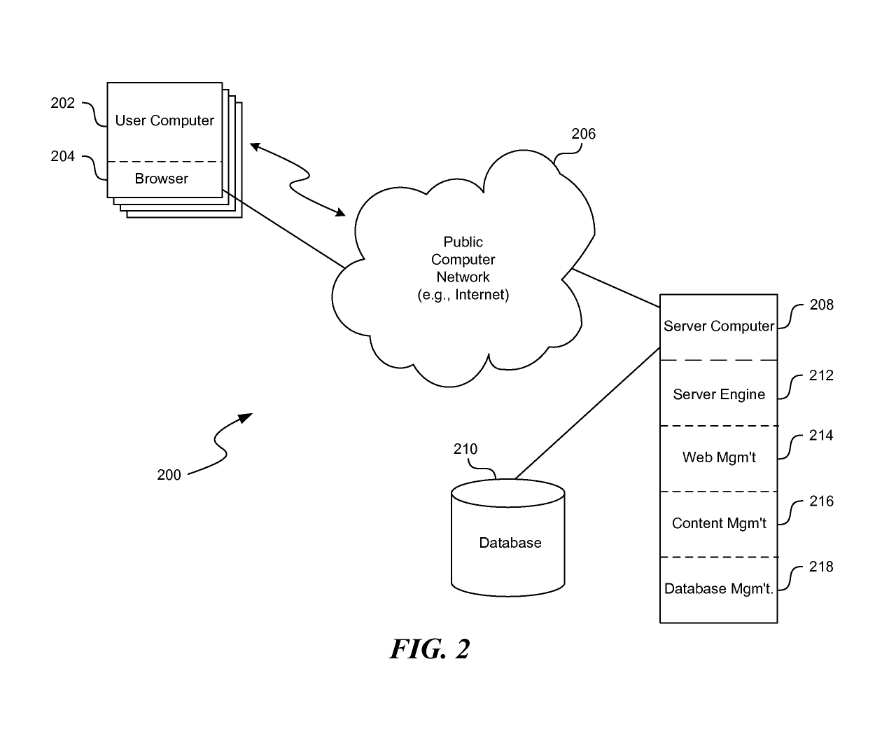

Aspects of the described technology may be practiced in a variety of other computing environments. For example, referring to FIG. 2, a distributed computing environment with a web interface includes one or more user computers 202 in a system 200, each of which includes a browser program module 204 that permits the computer to access and exchange data with the Internet 206, including web sites within the World Wide Web portion of the Internet. The user computers 202 may be substantially similar to the computer described above with respect to FIG. 1. User computers 202 may be personal computers (PCs) or mobile devices, such as laptops, mobile phones or tablets. The user computers 202 may connect to the Internet 206 wirelessly or through the use of a wired connection. Wireless connectivity may include any forms of wireless technology, such as a radio access technology used in 2G/3G/4G or other mobile standards. User computers 202 may include other program modules such as an operating system, one or more application programs (e.g., word processing, spread sheet applications, or Internet-enabled applications), and the like. The computers may be general-purpose devices that can be programmed to run various types of applications, or they may be single-purpose devices optimized or limited to a particular function or class of functions. More importantly, while shown with web browsers, any application program that can provide a graphical user interface to users may be employed, as described in detail below; the use of a web browsers and web interfaces are only used to provide a familiar example here. For example, a mobile application or “App,” has been contemplated, such as one used in Apple's® iPhone® or iPad® products, or one used in Android®-based products.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system and preserve the integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine 212 performs basic processing and operating system level tasks. The web page management component 214 handles the creation and display or routing of web pages. Users may access the server computer 208 by means of a URL associated therewith. The content management component 216 handles most of the functions of the embodiments described herein. The database management component 218 deals with storage and retrieval tasks associated with the database as well as queries to the database. In some embodiments, multiple server computers 208, each having one or more of the components 212-218, may be utilized.

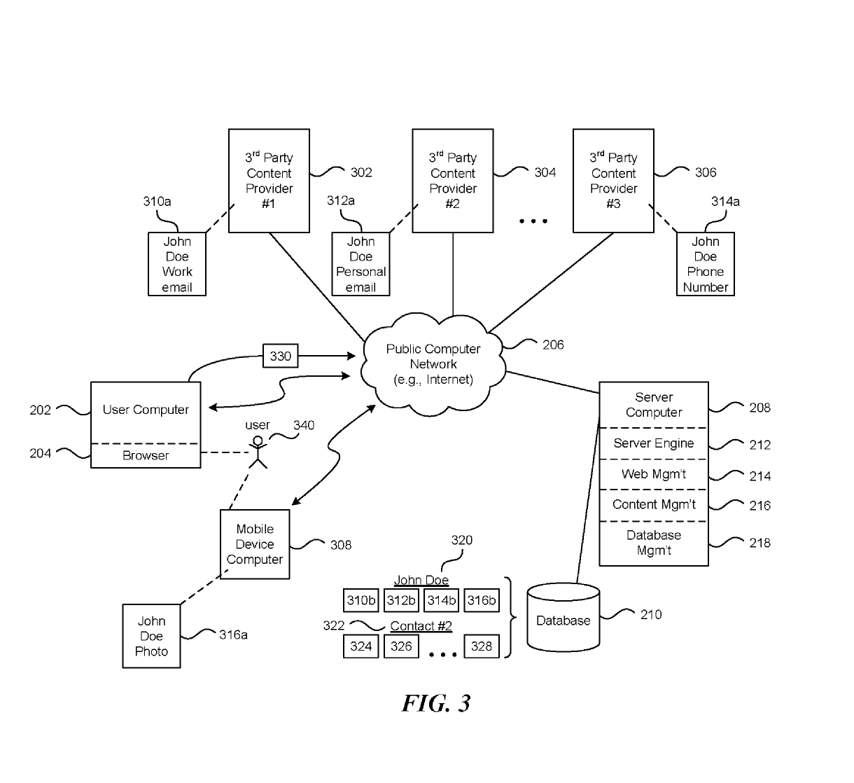

FIG. 3 is a block diagram illustrating a simple, yet suitable system in which data 310a-316a is gathered from external sources 302-308 and aggregated into contact cards 310b-316b that are associated with a particular contact 320/322. For example, user 340 can make a request 330, via computer 202 and/or mobile device 308, that server computer 208 create a new contact 322 or associate data 310a-316a with an existing contact 320. The request contains information about a contact 320/322, such as a name, e.g. “John Doe,” or one of the contact's email addresses.

In another embodiment the request 330, or a separate request (not shown), may contain third-party content provider 302-306 information (not shown) that can be used to collect additional contact data 310a-314a. For example, the user 340 may have an Outlook® account hosted by a Microsoft® Exchange Server 302, a Gmail® account hosted by Google® 304 and an account hosted by Facebook® 306, each of which may contain additional contact data 310a-314a for contact 320. In one implementation and by way of example, contact data 310a may contain John Doe's work email address, 312a may contain John Doe's personal email address, and 314a may contain John Doe's phone number.

In one embodiment, user 340 can solicit another user (not shown) to update the solicited user's contact information (e.g., 324-328). For example, user 340 can send, via computer 202 or mobile device computer 308, an email message requesting the solicited user to update her email address, etc. The email message to the solicited user can contain, among other things, a link, such as a uniform resource locator (“URL”). When accessed, the URL directs the solicited user's browser (similar to 204) to a web site (e.g., as provided by third party content provider #3 306). At the content provider web site 306, the solicited user can add or change her email address or other contact-related information. The additions or changes are reflected in a new contact card 314a that includes the solicited user's email address, for example.

The server 208, based on the information in the request 330 and/or information stored by the server 208, can collect contact data 310a-314a from 302-306, respectively. For example, via user's login information, the server 208 can login to providers 302-306 and collect contact data 310a-314a. The server 208 can aggregate, organize and/or de-duplicate the contact data 310a-314a into respective contact cards 310b-314b to form a single representative contact 320 (e.g. “John Doe”). Contact cards 310b-316b (and 324-328) can also contain data indicating the originating external source provider 302-308 of the contact data 310a-316a. Knowledge of the data's source can enable the user 340 and/or server 208 to prioritize contact 320/322 information.

In another embodiment, a user 340 can use computer 202 and/or mobile device 308 to add to or modify a contact 320/322. For example, via mobile device 308, a user 340 can associate an image 316a with a particular contact 320. The server 208 can receive the image 316a and generate a contact card 316b to associate the image 316a with the contact 320 and as originating from the mobile device 308.

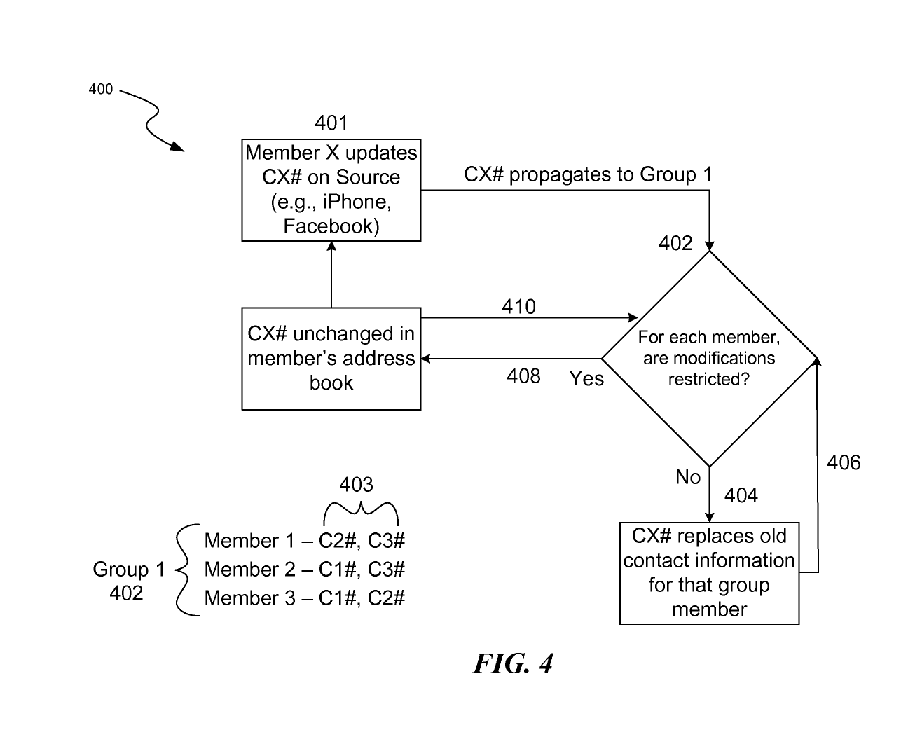

FIG. 4 is a flow chart 400 illustrating how to update groups in terms of contact information that has changed. Group 1 402 consists of member 1, member 2, and member 3. In this example, each member's address book 403 has contact information for each other group member. For example, Member 1 has contact information (C2#) for Member 2 and contact information (i.e., C3#) for Member 3, and so on. Various types of information are considered to be “contact information,” however, phone numbers are used by way of example. At step 401 a group member updates her contact information. For example, Member 1 may modify her old number to a new number. The source (e.g., iPhone, PC, Facebook®, Google®, etc.) of the updated information is stored and associated with the new number (not shown). In step. 405, the new number is sent for delivery to Group 1 402 where a decision is made whether a group member has a restriction on receiving members' updates. For example, a group member may choose not to update the new number in the member's address book based on the source of the update. This may be useful when determining the authenticity or staleness of the update (e.g., some sources may continually attempt to send old data as an “update.”) If that group member does not have a restriction, step 404 indicates that Member 1's new phone number, for example, is updated at the group member's address book. Step 406 illustrates that the decision at step 405 is repeated for each group member. If the member does have a restriction, step 408 illustrates that the new number is not updated to the group member's address book. Finally, step 410 illustrates that the decision at step 405 is repeated for each group member. The flow chart ends when all group members have been processed (not shown).

In general, the detailed description of embodiments of the described technology is not intended to be exhaustive or to limit the technology to the precise form disclosed above. While specific embodiments of, and examples for, the technology are described above for illustrative purposes, various equivalent modifications are possible within the scope of the described technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the described technology provided herein can be applied to other systems, not necessarily the system described herein. The elements and acts of the various embodiments described herein can be combined to provide further embodiments.

These and other changes can be made to the described technology in light of the above Detailed Description. While the above description details certain embodiments of the technology and describes the best mode contemplated, no matter how detailed the above appears in text, the described technology can be practiced in many ways. Details of the described technology may vary considerably in its implementation details, while still being encompassed by the technology disclosed herein. As noted above, particular terminology used when describing certain features or aspects of the described technology should not be taken to imply that the terminology is being redefined herein to be restricted to any specific characteristics, features, or aspects of the technology with which that terminology is associated. In general, the terms used in the following claims should not be construed to limit the described technology to the specific embodiments disclosed in the specification, unless the above Detailed Description section explicitly defines such terms. Accordingly, the actual scope of the described technology encompasses not only the disclosed embodiments, but also all equivalent ways of practicing or implementing the described technology.

The techniques introduced above can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware for implementing the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.),

The term “logic”, as used herein, can include, for example, special-purpose hardwired circuitry, software and/or firmware in conjunction with programmable circuitry, or a combination thereof.

Certain aspects of the invention are presented below in certain claim forms, but the applicant contemplates the various aspects of the invention in any number of claim forms. For example, while only one aspect of the invention may be recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to pursue additional claims after filing this application to pursue such additional claim forms, in either this application or in a continuing application.

I/We claim:

1. A computer-implemented method for managing contact information, the method comprising:
collecting, at a computing device, data from one or more data sources;
automatically generating, using the collected data, a card for each of the one or more data sources, wherein the card has an indication of which of the one or more data sources provided the data; and
sending the card or profile for display.

2. The method of claim 1, further comprising combining, into a single card, parts of the cards that were generated for the one or more data sources.

3. The method of claim 2, wherein without losing the data originally collected from the one or more data sources, the single card or profile is determined from the cards or profiles used to form the single card.

4. The method of claim 1, further comprising collecting one or more contacts from an electronic address book or contact list, wherein the one or more contacts are used for collecting the data from the one or more data sources.

5. The method of claim 1, further comprising displaying the one or more data sources that were used to generate the card or profile.

6. The method of claim 1, wherein the collected data is contact information.

7. The method of claim 1, wherein a data source of the one or more data sources is a mobile device.

8. The method of claim 1, wherein a data source of the one or more data sources is delivered via SMS.

9. A computer-implemented method for managing contact information, the method comprising:
storing, at a computing device, a plurality of original contact data associated with a contact, wherein each original contact data is from a different origination source, wherein an indicator associates each original contact datum with its respective origination source;
generating, without modifying the plurality of original contact data, a unified contact profile for display to a user, wherein the unified contact profile represents, as a single profile entry, the plurality of original contact data associated with the contact; and
sending at least one of the plurality of original contact data for display to a user, based on a user request to undo the unification.

10. The method of claim 9 wherein each of original contact datum is shared separately on a contact card.

11. The method of claim 9, further comprising receiving the original contact information over a network.

12. The method of claim 9, wherein the origination source is a mobile phone or web server.

13. A computer-implemented method for managing contact information, the method comprising:
receiving a plurality of unstructured pieces of contact data; and
creating a plurality of structured contact profiles, each profile based at least on one of the plurality of unstructured pieces of contact data, wherein at least one of the plurality of structured contact profiles is configured for display in an address book.

14. The computer-implemented method of claim 13, wherein the structured contact profile includes a name, phone number, email address, birth date, social profile or an address.

15. The computer-implemented method of claim 13, wherein the unstructured contact data is in a free-form format.

16. A system for managing contact information, the system comprising:
a processor;
a storage device;
a first component to receive a plurality of unstructured contact data; and
a second component to create a plurality of structured contact profiles, each profile based on at least one of the plurality of unstructured contact data, wherein at least one of the plurality of structured contact profiles is configured for display in an address book.

17. A method, comprising:
receiving a unified contact card, wherein the unified contact card has contact information merged from separate contact cards,
wherein each of the separate contact cards have an indicator of the source of its contact information, and
wherein the contact information in each of the separate cards is preserved after the merger of the separate contact cards into the unified contact card;
requesting that the unified contact card be disaggregated into the separate contact cards; and
receiving the disaggregated separate cards and the indicator of the source of the contact information.

18. A system for managing contact information, the system comprising:
a means for collecting data from one or more data sources;
a means for automatically generating, using the collected data, a card or profile for each of the one or more data sources, wherein the card or profile has an indication of which of the one or more data sources provided the data; and
a means for sending the card or profile for display.

19. A computer-implemented method for managing contact information, the method comprising:
receiving, via a source, an update to a first contact card, wherein the first contact card is shared with at least one group member;
determining whether a second contact card associated with the at least one group member allows modification, based on the update to the first contact card; and
modifying the second contact card with the update, when it is determined that the contact card allows the modification.

20. The computer-implemented method of claim 19 wherein determining whether a modification is allowed to the second contact card is based on the source of the update to the first contact card.

21. The computer-implemented method of claim 20 wherein the source of the update is one of a mobile device or a web site.
